(19) United States
(12) Patent Application Publication
(10) Pub. No.: US 2011/0149905 A1
(43) Pub. Date: Jun. 23, 2011

(54) HANDOVER METHOD BETWEEN eNBs IN MOBILE COMMUNICATION SYSTEM

(75) Inventor: Changki KIM, Daejeon (KR)

(73) Assignee: Electronics and Telecommunications Research Institute, Daejeon (KR)

(21) Appl. No.: 12/849,227

(22) Filed: Aug. 3, 2010

(30) Foreign Application Priority Data
Dec. 21, 2009 (KR) 10-2009-0128316

(51) Int. Cl. H04W 36/00

(52) U.S. Cl. 370/331

(57) ABSTRACT

A method for processing a handover procedure in a mobile communication system includes: receiving a message having radio access bearer information for radio resource re-establishment and packet forwarding from a target base station; searching uplink (UL) packet forwarding indicator information included in the message including the radio access bearer information; and forwarding UL/DL packets at a source base station when the UL packet forwarding information is set to ON. The method further includes, when UL packet forwarding indicator is set to ON, having bitmap information, which indicates whether or not to receive uplink (UL) packet data convergence protocol (PDCP) SDU packets, in an SN status transfer message transmitted to the target base station from the source base station.

### CROSS-REFERENCE(S) TO RELATED APPLICATION

The present invention claims priority of Korean Patent Application No. 10-2009-0128316, filed on Dec. 21, 2009, which is incorporated herein by reference.

### FIELD OF THE INVENTION

The present invention relates to a handover method between eNBs in a mobile communication system, and more particularly, to a handover method, which determines whether or not to perform UL packet forwarding in response to a UL packet forwarding indicator contained in a handover request acknowledge message during handover between base stations, and transmits a bitmap optimized for the variability of the bitmap, along with size information, at the time of UL packet forwarding.

### BACKGROUND OF THE INVENTION

An evolved universal mobile telecommunications system (E-UMTS) is an evolution of the long term evolution (LTE), being standardized by 3rd generation partnership project (3GPP), whose objective is to provide an IP-based high data rate, low-latency, and packet-optimized system in a conventional UMTS system. Thus, the E-UMTS system may be referred to as an LTE system.

In a conventional handover process, a source enhanced nodeB (eNB) receives a handover request acknowledgment from a target eNB, and then begins DL/UL data forwarding irrespective of what status the target eNB is in. That is, when the target eNB, which is a packet receiving side, intends to receive UL data using retransmission from UE after handover, rather than forwarding it, or intends to carry out handover without loss by its re-transmission in the absence of a packet data convergence protocol (PDCP) reordering function in the target eNB, problems may occur. This is because the source eNB at the transmitting side, rather than the target eNB at the receiving side in charge of reassembling of UL data, determines to forward UL packets.

Moreover, in the conventional handover process under the assumption that UL data forwarding is provided, in the case of PDCP SN status transfer of UL/DL data via an X2-AP interface, hyper frame number (HFN) and next Tx SN to be allocated to the next and acknowledgment or non-acknowledgment of reception of UL data which are equal to the size of the reordering window are made into a fixed bitmap of a 4096 bit string (512 bytes) and sent via UL to the target eNB, along with HFN and first missing sequence number (FMS).

By the way, this bitmap of a fixed size always has to be sent at a fixed size of 512 bytes to the target eNB from the source eNB every RB of each RNTI (unique ID assigned for each UE).

When FMS+4095-th data have not been received, a bitmap of 512 bytes can be transmitted. For example, if only the data corresponding to one SN of FMS+1 has not been received, a bitmap of only 1 byte is actually required. However, the inflexibility of having to send data at a fixed size of 512 bytes causes a delay of control signal transmission due to an increase of the size of a control signal and bitmap decoding time delay in the target eNB. As a result, an overall handover time delay may happen.

### SUMMARY OF THE INVENTION

Therefore, in view of the above, the present invention provides a more efficient handover method in which a target eNB transmits to the source eNB selection information for selecting whether or not to enable packet forwarding in a handover preparation step to allow the source eNB to determine whether to perform UL forwarding depending on the situation of the target eNB.

The present invention further provides an efficient handover process which can reduce the size of additional control signals not required for handover and reduce handover time by transmitting a bitmap equal to the size necessary for UL packet forwarding.

In accordance with an aspect of the present invention, there is a method for processing a handover procedure in a mobile communication system. The method includes: receiving a message including radio access bearer information for radio resource re-establishment and packet forwarding from a target base station; searching uplink (UL) packet forwarding indicator information included in the message including the radio access bearer information; and forwarding UL/DL packets at a source base station when the UL packet forwarding information is set to ON.

In accordance with another aspect of the present invention, there is provided a base station system including:

a transceiver unit for receiving a message including radio access bearer information from a target base station; a searching unit for searching uplink (UL) packet forwarding indicator information included in the message including the radio access bearer information; and a control unit for forwarding UL/DL packets when the UL packet forwarding information is set to ON.

### BRIEF DESCRIPTION OF THE DRAWINGS

The other objects and features of the present invention will become apparent from the following description of embodiments, given in conjunction with the accompanying drawings, in which:

FIG. 1 is a view showing a configuration of an E-UMTS network in accordance with the present invention;

FIGS. 2A and 2B are views showing a basic hierarchical structure of an interface protocol between UE and each node of eNB and EPC in the E-UMTS network;

FIG. 3 is a view showing control plane and user plane protocol stacks defined for base stations;

FIGS. 4A and 4B are flowcharts showing a handover procedure between the UE and the base station defined in the LTE;

FIG. 5 illustrates a base station system in accordance with the present invention;

FIG. 6 is a flowchart showing a method for processing a handover procedure in a mobile communication system in accordance with one embodiment of the present invention; and

FIG. 7 depicts information elements included in an SN status transfer message including the size information of a UL bitmap to be transmitted to a target base station from a source base station in accordance with the present invention.

### DETAILED DESCRIPTION OF THE EMBODIMENT

Hereinafter, an embodiment of the present invention will be described in detail with reference to the accompanying drawings which form a part hereof.

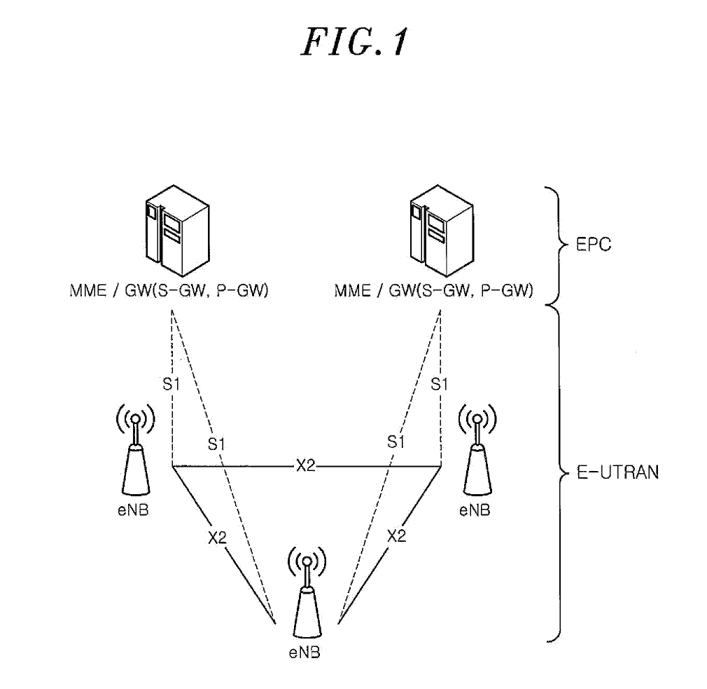

FIG. 1 is a view showing a configuration of an E-UMTS network in accordance with the present invention.

Referring to FIG. 1, the E-UMTS network can roughly be classified into an E-UTRAN (Evolved Universal Terrestrial Radio Access Network) and an EPC (Evolved Packet Core) connected thereto. The EPC is located at terminals of user equipment (UE) and a base station (evolved NodeB: eNB) and connected to an external network. The EPC includes a mobility management entity (MME) for managing the mobility of the UE and a gateway (GW) in charge of data traffic transmission between an external network and the E-UTRAN. Further, the GW has a serving gate way (S-GW) and a PDN gateway (P-GW).

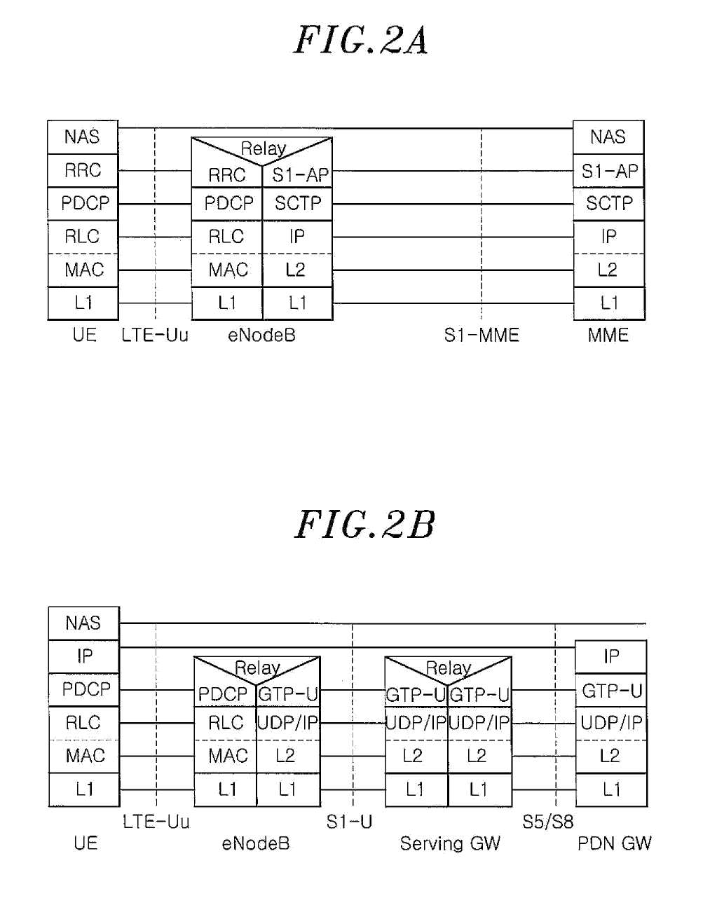

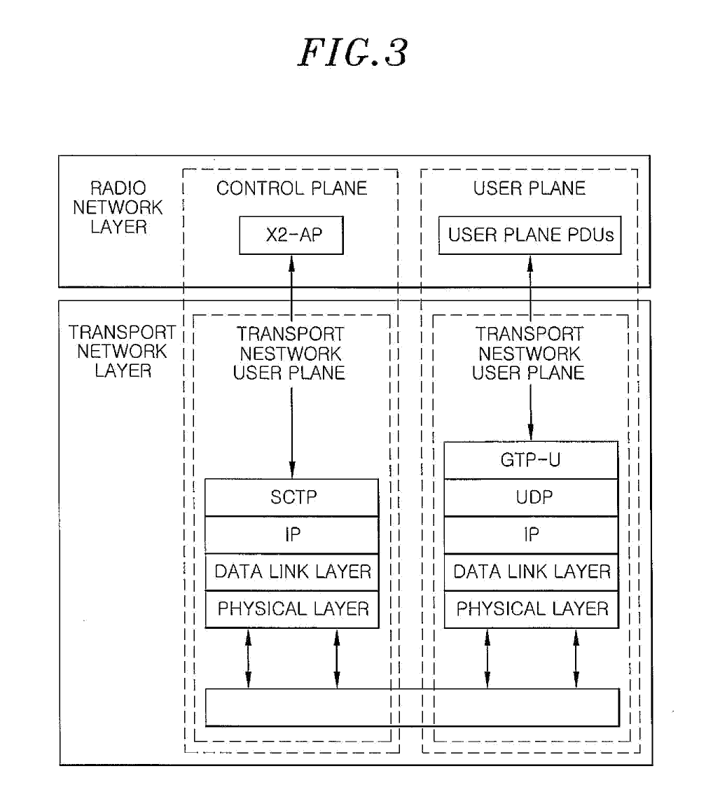

FIGS. 2A and 2B are views showing a basic hierarchical configuration of an interface protocol between the UE and each node of the eNB and EPC in the E-UMTS network. FIG. 2A shows a control plane stack for transmitting a control signal (signaling) and FIG. 2B shows a user plane stack for transmitting data.

Referring to FIGS. 2A and 2B, in a radio interface protocol between a UE and a base station based on 3GPP radio access network standards, each of the control plane and the user plane includes an L1 layer corresponding to a physical layer and an L2 layer formed of medium access control (MAC), radio link control (RLC) and packet data convergence protocol (PDCP) layers. An L3 layer corresponding to radio resource control (RRC) is defined in the control plane only.

The L1 layer and the MAC of the second layer are connected via a transport channel, and the MAC and the RLC are connected via a logical channel. The RLC layer supports reliable data transmission. The PDCP layer performs a header compression function to reduce the header size for internet protocol (IP) packets that contain relatively large and unnecessary control information. Accordingly, IP packets may be effectively transmitted over the radio interface having relatively small bandwidth. Also, the PDCP layer performs encryption of control plane data (Signaling Radio Bearer: SRB) and user plane data (Data Radio Bearer: DRB). The RRC (Radio Resource Control) defined in the control plane only is responsible for the control of logical channels, transport channels and physical channels with relation to the setup and release of radio bearers (RBs).

In addition to the radio interface protocol between the UE and the base station, protocols between the base station and the EPC are divided into a control plane protocol and a user plane protocol. Each of these protocols includes an S1-AP protocol and a GPRS (General Packet Radio Service) tunneling protocol (GTP-U) that are based on IP.

FIG. 3 is a view showing control plane and user plane protocol stacks defined for base stations. Referring to FIG. 3, the SCTP/IP-based X2-AP protocol is in charge of transmitting a control signal, such as context information of the UE required for handover between the base stations, and the UDP/IP-based GTP-U protocol is in charge of packet forwarding between the base stations via a logical path, such as a tunnel to ensure handover without loss.

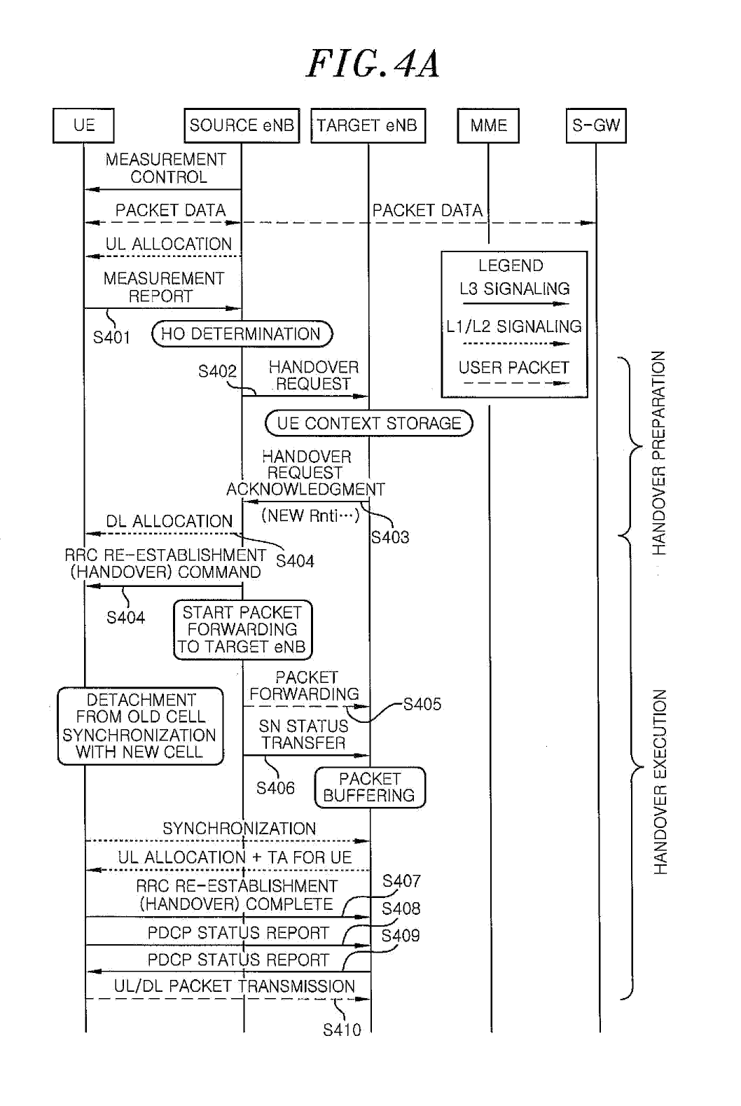

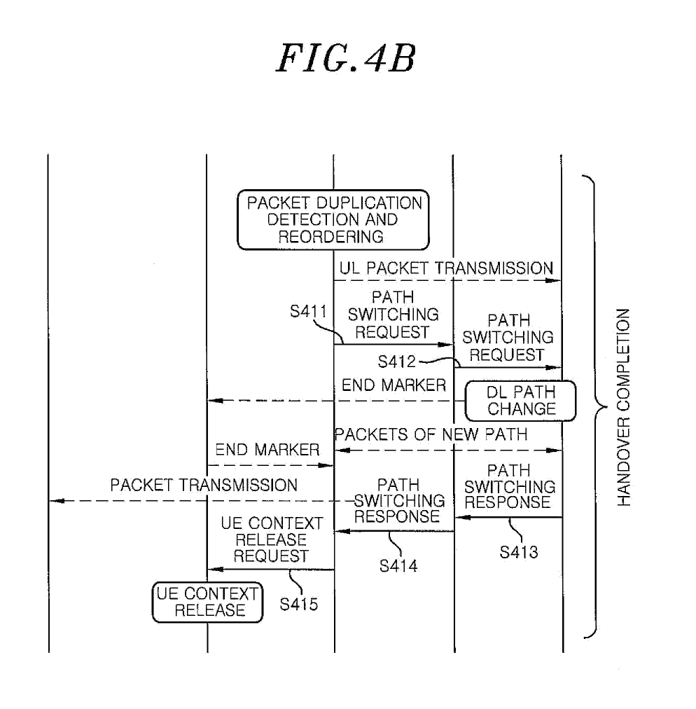

FIGS. 4A and 4B are flowcharts showing a handover procedure between the UE and the base station defined in the LTE.

Referring to FIGS. 4A and 4B, the UE performs measurement of the signal strengths with respect to each cell, and if a measurement value meets a particular reference designated by the base station, the UE transmits a measurement report message to a source eNB via an assigned uplink (UL) in step S401.

The source eNB determines handover to a target eNB with reference to the measurement report message received from the UE. Thereafter, the source eNB transmits context data of the corresponding UE to the target eNB to request preparation of handover in step S402.

After receiving a handover request message, the target eNB establishes a tunnel for packet forwarding between base stations and transmits a handover request acknowledge message to the source eNB together with radio resource establishment information, including a new C-RNTI (Control-Radio Network Temporary Identifier) with respect to the corresponding terminal, and a tunnel ID (TEID) for packet forwarding in step S403. Upon receipt of the handover request acknowledge message, the source eNB transmits an RRC re-establishment (handover) command to the UE in step S404, and then transmits UL/DL user data (PDCP SDU) to the target eNB via the established forwarding tunnel of GTP by using the PDCP layer of the source eNB in step S405.

At this time, for UL data forwarding, data PDCP SDUs, among the data from the UE received by the RLC, is forwarded to the target eNB, starting from the first data whose PDCP sequence number (SN) is discontinuous. For DL data forwarding, data PDCP SDUs whose reception has not been acknowledged by the UE, among the data transmitted to the UE by the PDCP, is transmitted to the target eNB. Also, the source eNB sends an SN status transfer message, along with UL/DL PDCP SN information (more specifically including HFN, SN, and, in the case of UL forwarding, a UL bitmap) to the target eNB by X2-AP in order to ensure handover without loss in step S406.

Upon receipt of the RRC re-establishment (handover) command, the UE re-establishes a radio resource with the target eNB including timing synchronization, and transmits an RRC re-establishment (handover) complete message to the target eNB in step S407. Afterwards, the PDCP layer of the UE sends a re-transmission request to the target eNB by a PDCP status report in order to request the re-transmission of DL packets to the SN that have not been received at the PDCP level in step S408. Also, the UE transmits the packets of the SN whose reception has not been acknowledged by the source eNB to the target eNB before a handover at the PDCP level of the UE in steps S408 and S410.

Herein, the PDCP of the target eNB buffers UL/DL packets received from the source eNB, and receives the PDCP SN information of the UL/DL packets by the X2-AP. Thereafter, upon completion of RRC re-establishment with the UE, the transmission of the buffered DL data to the UE is started. The UL data received from the UE, along with the UL forwarding data, is reordered with the packets of the PDCP level by PDCP SN reordering and duplication detection, and then is transmitted to the GW. At this time, a PDCP status report is transmitted to the UE referring to the SN information delivered by the X2-AP, to request the re-transmission of UL packets in steps S409 and S410

Thereafter, the target eNB sends a path switching request to the S-GW via the MME in order to change the eNB to which the UE belongs in steps S411 and S412. Then, upon completion of path switching, the S-GW transmits, to the source eNB, an end marker packet indicating that all packets have been transmitted to the source eNB which is the corresponding old path. Afterwards, upon receipt of a path switching response in steps S413 and S414, the target eNB transmits an UE context release request to the source eNB in step S415.

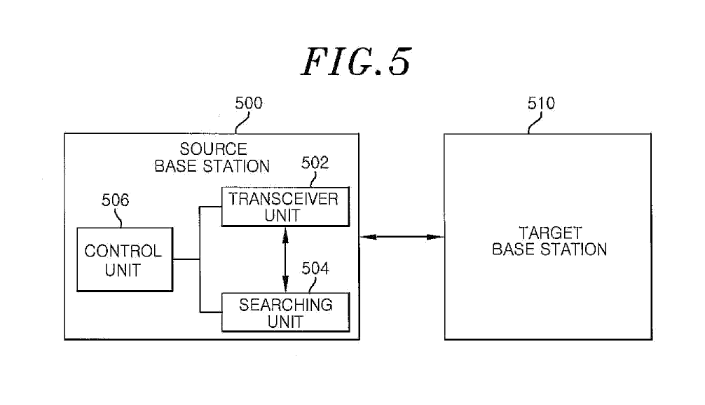

FIG. 5 shows a base station system in accordance with the present invention. Referring to FIG. 5, the base station system includes a source base station 500 and a target base station 510. Further, the source base station 500 includes a transceiver unit 502, a searching unit 504, and a control unit 506.

The transceiver unit 502 receives a message including radio access bearer information for radio resource re-establishment and packet forwarding from the target base station 510. At this time, the message including the radio access bearer information is preferably a handover request acknowledge message.

The searching unit 504 searches UL packet forwarding indicator information included in the message of the radio access bearer information.

When the UL packet forwarding indicator information is set to ON, the control unit 506 forwards UL/DL packets.

The control unit 506 establishes a tunnel with a tunnel ID received from the target base station 510, and then transmits the UL packets. Here, the tunnel ID is preferably a GTP tunnel ID (TEID).

On the other hand, when the UL packet forwarding indicator is set to OFF, the control unit 506 does not transmit UL packet data to the target base station 510 but discards it even if it exists. In this case, the control unit 506 does not include bitmap information indicative of the reception or non-reception of a UL PDCP SDU packet in the SN status transfer message to be transmitted to the target base station, but includes only UL/DL COUNT (PDCP SN and HFN) information therein.

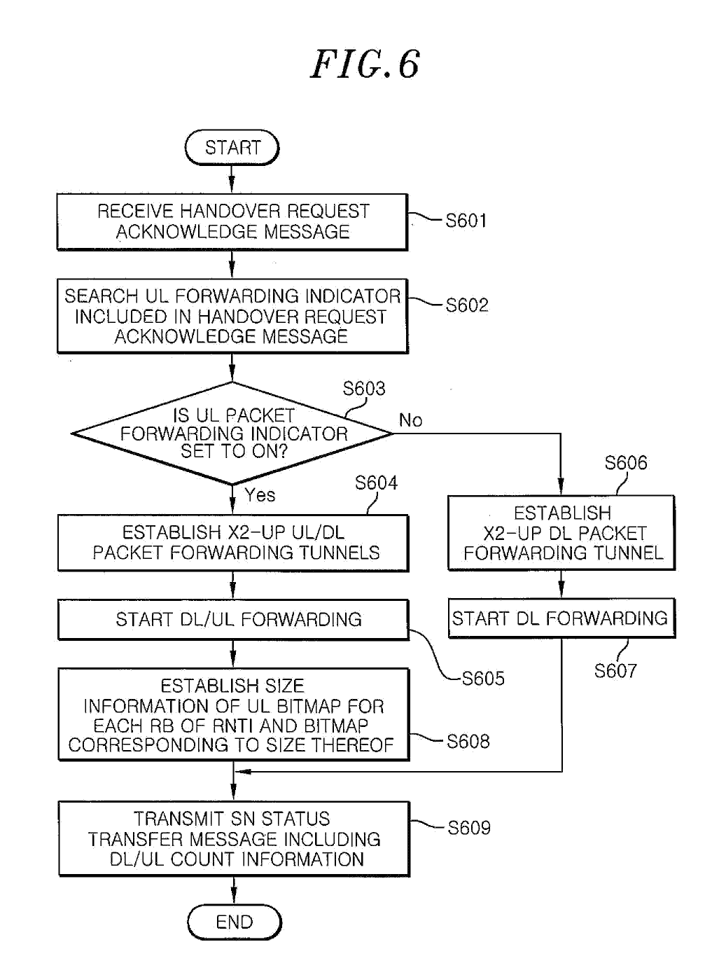

FIG. 6 is a flowchart showing a method for processing a handover procedure in a mobile communication system in accordance with the embodiment of the present invention.

Referring to FIG. 6, in a preparation process of handover between eNBs of the UE, when the source eNB receives a handover request acknowledge message from the target eNB in step S601, the source eNB searches a UL packet forwarding indicator included in the handover request acknowledge message in step S602.

Next, the source eNB determines whether or not to perform UL packet forwarding based on the searched information in step S603.

When the UL packet forwarding indicator is set to ON, the source eNB establishes respective tunnels with X2-UP GTP UL/DL tunnel IDs received from the target eNB in step S604, and then starts the transmission of UL/DL packets in step S605. Also, bitmap information of from FMS (First Missing Sequence number) to LRS (Last Received Sequence number) of the UL packets is created, and the size thereof is detected in step S608. Then, an SN status transfer message of X2-AP including the bitmap and DL/UL COUNT information is transmitted to the target eNB in step S609.

On the other hand, if the UL data packet forwarding indicator is set to OFF, the source eNB establishes a DL packet forwarding tunnel only with the X2-UP GTP DL tunnel ID received from the target eNB in step S606 to starts DL packet transmission in step S607. In this case, because there is no UL packet forwarding, an SN status transfer message of X2-AP including only the UL/DL count information, but without UL packet bitmap information, is transmitted to the target eNB in step S609.

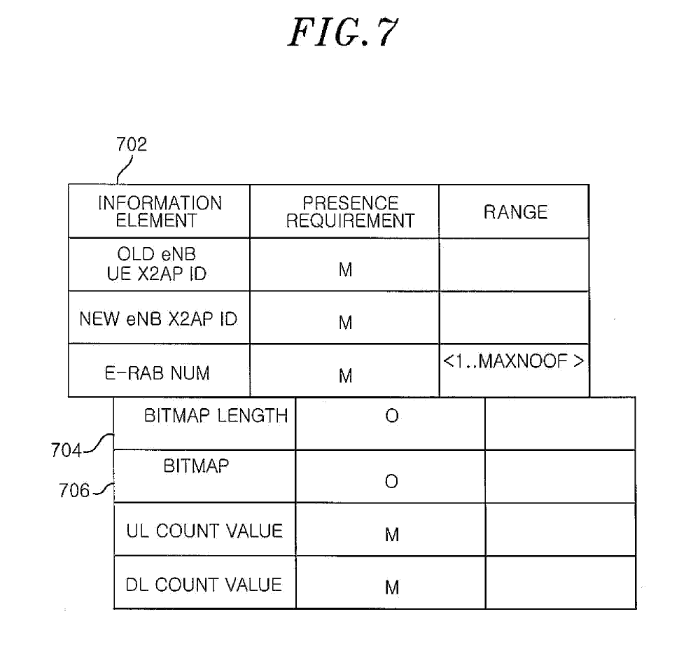

FIG. 7 shows information elements included in an SN status transfer message including the size information of a UL bitmap to be transmitted to a target base station from a source base station in accordance with the present invention.

Referring to FIG. 7, an E-RAB num 702 indicates the maximum number of RBs for each RNTI, which is defined as 256 in the conventional specification. Bitmap length information 704 and a bitmap 706 are included only when the UL forwarding indicator is set. If the UL forwarding indicator is set, the bitmap length 704 indicates a byte unit length including FMS+1 to LRS.

In accordance with the present invention, more desirable handover based on a status of a receiving side is enabled by forwarding UL packets depending on a UL packet forwarding indicator included in a handover request acknowledge message in the handover preparation step. Moreover, at the time of UL packet forwarding, it is possible to reduce the size of a control signal unnecessary for handover between base stations and reduce bitmap processing time in the target base station by transmitting a bitmap optimized for the variability of the bitmap, along with size information, when transmitting bitmap information of UL packets. As a result, more efficient handover can be carried out.

While the invention has been shown and described with respect to the particular embodiments, it will be understood by those skilled in the art that various changes and modifications may be made without departing from the of the invention as defined in the following claims.

What is claimed is:

1. A method for processing a handover procedure in a mobile communication system, the method comprising:
receiving a message including radio access bearer information for radio resource re-establishment and packet forwarding from a target base station;
searching uplink (UL) packet forwarding indicator information included in the message including the radio access bearer information; and
forwarding UL/DL packets at a source base station when the UL packet forwarding information is set to ON.

2. The method of claim 1, wherein the message including the radio access bearer information is a handover request acknowledge message.

3. The method of claim 2, wherein the radio access bearer information includes an UL packet forwarding indicator.

4. The method of claim 1, wherein said forwarding UL/DL packets includes establishing, at the source base station, a tunnel with a tunnel ID received from the target base station before transmitting UL packets.

5. The method of claim 4, wherein the tunnel ID is a general packet radio service (GPRS) tunneling protocol (GTP) tunnel ID (TEID).

6. The method of claim 3, further comprising:
when the UL packet forwarding indicator is set to ON, including bitmap information, which indicates whether or not to receive uplink (UL) packet data convergence protocol (PDCP) SDU packets, in an SN status transfer message transmitted to the target base station from the source base station.

7. The method of claim 6, further comprising:
detecting a size of the bitmap information and establishing a bitmap equal to the size of the bitmap information.

8. The method of claim 7, wherein the size of the bitmap information is determined as a bitmap size of FMS to LRS of the UL packets.

9. The method of claim 3, further comprising:
when the UL packet forwarding indicator is set to OFF, preventing the transmission of UL packet data to the target base station from the source base station and discarding it even if the UL packet data exists.

10. The method of claim 9, further comprising:
when the UL packet forwarding indicator is set to OFF, preventing the inclusion of bitmap information which indicates whether or not to receive UL PDCP SDU packets, in an SN status transfer message transmitted to the target base station from the source base station, but allowing the inclusion of UL/DL count information only in the SN status transfer message.

11. A base station system comprising:
a transceiver unit for receiving a message including radio access bearer information from a target base station;
a searching unit for searching uplink (UL) packet forwarding indicator information included in the message including the radio access bearer information; and
a control unit for forwarding UL/DL packets when the UL packet forwarding information is set to ON.

12. The base station system of claim 11, wherein the message including the radio access bearer information is a handover request acknowledge message.

13. The base station system of claim 12, wherein the radio access bearer information includes an UL packet forwarding indicator.

14. The base station system of claim 11, wherein the control unit establishes a tunnel with a tunnel ID received from the target base station before transmitting UL packets.

15. The base station system of claim 14, wherein the tunnel ID is a general packet radio service (GPRS) tunneling protocol (GTP) tunnel ID (TEID).

16. The base station system of claim 13, wherein, when the UL packet forwarding indicator is set to ON, the control unit includes bitmap information, which indicates whether or not to receive uplink (UL) packet data convergence protocol (PDCP) SDU packets, in an SN status transfer message transmitted to the target base station from the source base station.

17. The base station system of claim 16, wherein the control unit detects a size of the bitmap information to establish a bitmap equal to the size of the bitmap information.

18. The base station system of claim 17, wherein the size of the bitmap information is determined as a bitmap size of from FMS to LRS of the UL packets.

19. The base station system of claim 13, wherein, when the UL packet forwarding indicator is set to OFF, the control unit does not transmit UL packet data to the target base station but discards it even if the UL packet data exists.

20. The base station system of claim 19, wherein, when the UL packet forwarding indicator is set to OFF, the control unit does not include bitmap information, which indicates whether or not to receive UL PDCP SDU packets, in an SN status transfer message transmitted to the target base station, but includes UL/DL count information only in the SN status transfer message.
